(19) United States
(12) Patent Application Publication
(10) Pub. No.: US 2014/0371122 A1
(43) Pub. Date: Dec. 18, 2014

(54) DUST-REMOVING CLEANING AGENT AND CLEANING METHOD USING SAME

(71) Applicant: 3M INNOVATIVE PROPERTIES COMPANY, St. Paul, MN (US)

(72) Inventors: Namiko Ikegaya, Tokyo (JP); Saki Hiura, Hyogo (JP); Masahi Norimoto, Kanagawa (JP)

(21) Appl. No.: 14/373,912

(22) PCT Filed: Jan. 24, 2013
(86) PCT No.: PCT/US2013/022886

§ 371 Date: Jul. 23, 2014

(30) Foreign Application Priority Data
Jan. 27, 2012 (JP) 2012-014957

(51) Int. Cl. C11D 7/50; C11D 7/26

(52) U.S. Cl. CPC C11D 7/5018; C11D 7/261
USPC 510/109

(57) ABSTRACT

To provide a dust-removing cleaning agent for reducing the re-adherence of particles of dust, grime, and the like to a substrate after these particles have been removed from the substrate. A dust-removing cleaning agent having a particle adherence-reducing function and containing a fluoride solvent and an alcohol having at least four carbon atoms in the backbone thereof, and a cleaning method using the same.

### TECHNICAL FIELD

The present invention relates to a dust-removing cleaning agent having a particle adherence-reducing function, and a cleaning method using the same.

### BACKGROUND

Fluoride solvents or mixed solvents containing a fluoride solvent and another typical cleaning solvent are used to remove contaminants adhering to the surface of a substrate such as metal, glass, ceramic, plastic, fabric, or the like.

Japanese Translation of Published PCT Application H10-512609 discloses a cleaning composition containing at least one type of partially fluorinated ether compound and a method of removing contaminants from the surface of a substrate using this sort of composition. These compositions are described as being capable of use singly or in combination with another typical cleaning solvent (for example, alcohols, ethers, alkanes, alkenes, perfluorocarbons, tertiary perfluoroamines, perfluoroethers, cycloalkanes, esters, ketones, aromatic hydrocarbon, siloxanes, hydrochlorocarbons, hydrochlorofluorocarbons, and hydrofluorocarbons).

However, while dust, grime, bits of broken parts, cullet, debris, inorganic matter, metallic oxides, polymers, and other particles that do not readily dissolve in cleaning solvents may be temporarily removed from the substrate through immersion in a cleaning solvent, the particles can re-adhere to the substrate when the latter is removed from the cleaning solvent. The reduction of such re-adhering particles is particularly demanded in fields requiring more precise cleaning, such as those in which the substrate is a semiconductor, wafer board (used in semiconductors, LEDs, hard disks, and the like), electronic device, medical instrument, base member, sensor, lens, or the like.

### SUMMARY

The present invention provides a dust-removing cleaning agent for reducing re-adherence of particles of dust, grime, and the like to a substrate after these particles have been removed from the substrate.

According to one embodiment of the present invention, a dust-removing cleaning agent is provided, which has a particle adherence-reducing function and contains a fluoride solvent, and an alcohol having at least four carbon atoms in the backbone thereof.

According to another embodiment of the present invention, a method for removing contaminants from a surface of a substrate is provided, including the steps of bringing the dust-removing cleaning agent having a particle adherence-reducing function and containing a fluoride solvent and an alcohol having at least four carbon atoms in the backbone thereof and the substrate into contact, and removing the dust-removing cleaning agent from the substrate.

According to the present disclosure, an amount of particle adherence after cleaning can be reduced, thereby allowing for more precise cleaning.

### DETAILED DESCRIPTION

A detailed description for the purpose of illustrating representative embodiments of the present invention is given below, but these embodiments should not be construed as limiting the present invention.

The dust-removing cleaning agent of the present disclosure contains a fluoride solvent and an alcohol having at least four carbon atoms in the backbone thereof. Examples of fluoride solvents that can be used include c-C₆F₁₁CF₂OC₂H₅, c-C₆F₁₁CF₂OCH₃, 4-CF₃₋c-C₆F₁₀CF₂OCH₃, C₄F₉OCH₃, c-C₆F₁₁OCH₃, (CF₃)₂CFCF₂OCH₃, (CF₃)₂CFCF₂OC₂H₅, C₈F₁₇OCH₃, C₂F₅CF(OCH₃)CF(CF₃)₂, CF₃CF(OCH₃)CF(CF₃)₂, C₅F₁₁OCH₃, C₅F₁₁OC₂H₅, C₃F₇OCH₃, C₈F₁₇—O—C₂F₄H, C₇F₁₅—O—C₂F₄H, C₆F₁₃—O—C₂F₄—O—CF₂H, C₄F₉—O—C₂F₄H, HCF₂CF₂—O—CF₂CF₂—O—CF₂CF₂H, C₄F₉—O—(CF₂)₅H, C₅F₁₁—O—(CF₂)₅H, C₈F₁₇—O—(CF₂)₅H, C₄F₉—O—CF₂C(CF₃)₂CF₂H, H(CF₂)₄—O—(CF₂)₄H, Cl(CF₂)₄—O—(CF₂)₄H, C₆F₁₃—O—C₂F₄H, C₄F₉₋O—(CF₂)₄—O—(CF₂)₃H, (C₂F₅)₂CFCF₂—O—C₂F₄H, c-C₆F₁₁CF₂—O—C₂F₄H, C₄F₉₋O—C₂F₄—O—C₃F₆H, C₆F₁₃—O—C₄F₈H, C₆F₁₃—O—C₃F₆H, C₅F₁₁—O—(CF₂)₄H, C₄F₉—O—C₃F₆H, C₈F₁₇OCF₂OC₃F6H, HC3F₆OC₃F₆H, C₄F₉OC₂H₅, C₂F₅CF(OCH₃)CF(CF₃)₂, C₂F₅CF(OCH₃)C₃F₇, (CF₃)₂C(OCH₃)C₃F₇, C₂F₅CCF₃(OCH₃)C₂F₅, C₃F₇OCH₃, CF₃CF(CF₃)OCH₃, C₃HF₆CH(CH₃)OC3HF₆, C₂HF₄CH(CH₃)OC₄HF₈, C₃HF₆CH(CH₃)C₂F₄OCHF₂, C₂HF₄CH(CH₃)OCF₂C(CF₃)CHF₂, CF₃CH₂OCF₂CHF₂, and other hydrofluoroethers; CH₂FCF₂CFH₂, CHF₂(CF₂)₂CF₂H, CF₃CH₂CF₂CH₂CF₃, CF₃(CFH)₂CF₂CF₃, CF₃(CF₂)₄CF₂H, CF₃(CF₂)₅CH₂CH₃, CH₃CF₂CH₂CF₃, and other hydrofluorocarbons (HFCs); CF₃CF₂CHCl₂, CClF₂CF₂CHClF, CCl₂FCH₃, and other hydrochloroflurocarbons (HCFCs); C₅F₁₂, C₆F₁₄, C₇F₁₆, C₈F₁₈, CF₃₋N(C₂F₄)₂O, C₂F₅—N(C₂F₄)₂O, C₃F₇—N(C₂F₄)₂O, and other perfluorocarbons (PFCs); CF₃COCF₂COCF₃, C₂F₅COC₃F₇, (CF₃)₂CFCOCH(CF₃)₂, (CF₃)₂CFCOCH(CF₃)₂, and other perfluoroketones (PFKs); and CF₃CH═CHC₂F5, CF₃CF═CH₂, C₂F₅CF═CFCF(OCH₃)CF₂CF₃, CF₃CF═CFCF(OCH₃)CF₃, CHF₂CF═CH₂, CH₃CF═CF₂, CH₂FCF═CF₂, CH₂FCH═CF₂, CHF₂CH═CHF, CF₃CF═CFCF₃, C₂F₅CF═CFCF(OCH₃)CF₂CF₃, CF₂(OCH₃)CF═CF—CH₂CF₃, and other hydrofluoroolefins (HFOs).

Of these fluoride solvents, HFEs and HFCs can be used out of consideration of global warming potential (GWP), ozone depletion potential (ODP), and other environmental concerns, as well as compatibility with the alcohol and the like.

Of these fluoride solvents, a solvent having a boiling point of at least approximately 30° C. and no more than approximately 200° C. can be used.

Examples of alcohols having at least four carbon atoms in the backbone thereof include 1-butanol, 1-pentanol, 1-hexanol, 1-heptanol, 1-octanol, 1-nonol, 1-decanol, 2-pentanol, 3-pentanol, 2-hexanol, 3-hexanol, 2-heptanol, 3-heptanol, 4-heptanol, 2-octanol, 3-octanol, 4-octanol, and other alcohols having unbranched backbones; and 2,2-dimethyl-1-hexanol, 3-ethyl-1-butanol, 2,3-dimethyl-1-pentanol, 4,4-dimethyl-2-hexanol, 3-methyl-2-butanol, 3,4-diethyl-2-heptanol, and other alcohols having branched backbones. Of these, a normal alcohol may be used. Additionally, an alcohol having at least five carbon atoms in the backbone thereof may be used.

An alcohol containing an atom other than carbon, hydrogen, and oxygen, such as a halogenated alcohol or the like, may be used.

At least 0.04 mol of alcohol having at least four carbon atoms in the backbone thereof can be added to 1,000 g fluoride solvent. If the amount of alcohol is less than 0.04 mol, re-adherence reduction effects may be insufficient.

An amount of alcohol no greater than the saturated solubility can be added. This is because separation of the alcohol and the fluoride solvent into two layers can lead to the alcohol rising to the upper layer, creating the risk of the alcohol igniting.

The dust-removing cleaning agent of the present disclosure can dissolve or remove a variety of contaminants from the surface of a substrate. For example, materials can be removed such as low-hydrocarbon contaminants, more highly polymeric hydrocarbon contaminants such as mineral oil, grease, and the like, perfluoropolyethers, bromotrifluoroethylene oligomers (gyroscope fluids), chlorotrifluoroethylene oligomers (hydraulic fluid and lubricants), silicone oils, grease, solder solvents, particles, and other contaminants encountered when cleaning precision electronic devices, metals, medical instruments, and the like.

Furthermore, among the removed contaminants, the re-adherence of particles not readily soluble in the dust-removing cleaning agent to the surface of the substrate can be reduced. The dust-removing cleaning agent can be used in the form of a liquid, and a desired known technique of bringing the fluid into contact with a substrate can be used. For example, the substrate may be immersed in the dust-removing cleaning agent. An elevated temperature, ultrasonic energy, and/or vibrations can also be used to promote cleaning.

The cleaning method according to the present invention can be executed by bringing a contaminated substrate into contact with the dust-removing cleaning agent described above. Either an organic substrate or an inorganic substrate can be the substrate cleaned using the method of the present invention. Typical examples of substrates include metal, ceramic, glass, polycarbonate, polystyrene, acrylonitrile-butadiene-styrene copolymer, and composites of the foregoing materials. The method is especially effective for precision cleaning of electronic parts (such as circuit boards), optical media, magnetic media, and medical instruments.

### EXAMPLES

Examples of the present invention are presented below, but the present invention is in no way restricted to these examples.

The particle adherence-reducing function of the dust-removing cleaning agent and method according to the present invention was evaluated by measuring an amount of adhering particles as described below.

### Particle Adherence Measuring Method

0.08 g of polystyrene latex (PSL) particles (Moritex Corporation; product name DO-05; guaranteed average particle size of 5.0 μm±0.4 μm) was mixed as particles with 1,000 g of cleaning agent. While the cleaning agent was stirred using a stirrer (rotational velocity: 150 to 170 rpm), a clean wafer (4-inch, Si bare wafer) was placed into the cleaning agent over three seconds, left immersed therein for four seconds, and removed over four seconds. An amount of PSL particles adhering to the wafer was then measured using a wafer surface analyzer (Topcon Corporation; product name WM-7S).

### Examples 1 through 4

0.083 mol of 1-butanol, 1-pentanol, 1-hexanol, and 1-heptanol was mixed with 1,000 g of HFE (Sumitomo 3M Ltd.; product name: Novec™ high performance fluid 7100) (HFE-7100) to create Working Examples 1, 2, 3, and 4, respectively. The amount of particle adherence was measured for each. The results are shown in Table 1.

### Comparative Example 1

High performance Novec(TM) fluid 71IPA (HFE-71IPA) produced by Sumitomo 3M Ltd., in which 0.83 mol/kg isopropyl alcohol was added to HFE-7100, was used for Comparative Example 1, and the amount of adhering particles was measured. The results are shown in Table 1.

### Comparative Examples 2 through 5

0.083 mol of methanol (Wako Pure Chemical Industries, Ltd.; special grade), ethanol (Wako Pure Chemical Industries, Ltd.; special grade), 1-propanol (Wako Pure Chemical Industries, Ltd.; special grade), and isopropyl alcohol (Wako Pure Chemical Industries, Ltd.; special grade 2-propanol) were mixed with 1,000 g HFE-7100 to obtain Comparative Examples 2, 3, 4, and 5, respectively. The amount of particles adhering to each was measured. The results are shown in Table 1.

TABLE 1

| | | Particle Ratio (Number |
|---|---|---|
| | Alcohol Type | of particles/wafer) |
| Working Example 1 | 1-Butanol | 685 |
| Working Example 2 | 1-Pentanol | 458 |
| Working Example 3 | 1-Hexanol | 427 |
| Working Example 4 | 1-Heptanol | 565 |
| Comparative Example 1 | HFE-71IPA | 1222 |
| Comparative Example 2 | Methanol | 1325 |
| Comparative Example 3 | Ethanol | 1359 |
| Comparative Example 4 | 1-Propanol | 1255 |
| Comparative Example 5 | Isopropyl Alcohol | 1747 |

### Particle Adherence Comparison

The amount of particle adherence in the case of the cleaning agent of Comparative Example 3 (ethanol) was calculated from the results shown in Table 1, taking the amount of particle adherence in the case of the cleaning agent of Working Example 3 (1-hexanol) as 1. The results thereof are shown in Table 2. For other fluoride solvents (Asahi Glass Co., Ltd., product name Asahiklin AE-3000; and Mitsui-DuPont Fluorochemical Co., Ltd., product name Vertrel™ XF), the amount of particle adherence when 1-hexanol (0.083 mol/kg) was added and when ethanol (0.083 mol/kg) was added were measured as well, and a ratio thereof was similarly calculated. The results thereof are shown in Table 2.

TABLE 2

| | Change Rate of Particle Ratio |
|---|---|
| | (Ethanol/1-Hexanol) |
| HFE-7100 | 3.2 |
| AE-3000 | 6.3 |
| Vertrel XF | 3.2 |

The amount of particle adherence for Working Example 3 (1-hexanol) and Comparative Example 3 (ethanol) was measured in a manner similar to that described above, with the exception that the particles used in the particle adherence measurement method were not PSL particles, but rather SiO₂ (Fuso Chemical Co., LTD.; fine spherical powdered silica, SP-IB, average particle size 1.0 μm) or Si₃N₄ (Alfa Aesar, A Johnson Matthey Company; silicon (4) nitride, Electronic Grade, 99.85% (metal basis), 94% α-phase), and a ratio thereof was calculated. The results thereof are shown in Table 3.

TABLE 3

| | Change Rate of Particle |
|---|---|
| | Ratio (Ethanol/1-Hexanol) |
| PSL | 3.2 |
| SiO₂ | 3.5 |
| Si₃N₄ | 1.7 |

As can be seen from the above results, the amount of particle adherence was low when an alcohol having at least four carbon atoms in the backbone thereof was added.

### Differences in Particle Adherence According to Amount of Added Alcohol

A mol number of 1-butanol added to 1,000 g HFE-7100 was varied and the amount of particle adherence measured. The results are shown in Table 4.

TABLE 4

| 1-Butanol Added | Particle Ratio |
|---|---|
| Concentration (mol/kg) | (Number of particles/wafer) |
| 0.0000 | 2837 |
| 0.0083 | 2695 |
| 0.0166 | 2362 |
| 0.0300 | 1414 |
| 0.0400 | 809 |
| 0.0600 | 667 |
| 0.0830 | 667 |
| 0.1660 | 862 |
| 0.8300 | 959 |

1. A dust-removing cleaning agent having a particle adherence-reducing function, the agent comprising a fluorinated solvent and an alcohol having at least four carbon atoms in the backbone thereof.

2. The dust-removing cleaning agent according to claim 1, wherein the alcohol is an alcohol having an unbranched backbone.

3. The dust-removing cleaning agent according to claim 1, wherein the alcohol is a normal alcohol.

4. The dust-removing cleaning agent according to claim 1, having at least 0.04 mol of the alcohol per 1,000 g of the fluorinated solvent.

5. The dust-removing cleaning agent according to claim 1, wherein the fluorinated solvent is a hydrofluoroether and/or a hydrofluorocarbon.

6. A method for removing contaminants from a surface of a substrate, the method comprising the steps of:
bringing into contact a dust-removing cleaning agent having a particle adherence-reducing function and containing a fluorinated solvent and an alcohol having at least four carbon atoms in the backbone thereof and a substrate; and
removing the dust-removing cleaning agent from the substrate.
